(19) United States
(12) Patent Application Publication
(10) Pub. No.: US 2020/0242962 A1
(43) Pub. Date: Jul. 30, 2020

(54) OPERATION RANGE SETTING APPARATUS, GAME APPARATUS, OPERATION RANGE SETTING METHOD, AND NON-TRANSITORY COMPUTER-READABLE RECORDING MEDIUM

(71) Applicant: Sharp Kabushiki Kaisha, Sakai City (JP)

(72) Inventor: RIEKO TODA, Sakai City (JP)

(21) Appl. No.: 16/777,699

(22) Filed: Jan. 30, 2020

(30) Foreign Application Priority Data
Jan. 30, 2019 (JP) 2019-014718

(51) Int. Cl. G09B 19/00; G06F 3/041; G09B 5/06

(52) U.S. Cl. CPC G09B 19/00; G09B 5/06; G06F 3/0418

(57) ABSTRACT

The operation range setting apparatus includes a display controller that displays in order each of a plurality of object images at a different position on a display screen of a touch panel, an input detector that detects a touch position touched by a user on the display screen with respect to each of the object images displayed on the display screen by the display controller, and an operation range setter that sets an operation range indicating a range on the display screen where the user can operate on the basis of a plurality of touch positions corresponding to the object images detected by the input detector.

### INCORPORATION BY REFERENCE

This application is based upon and claims the benefit of priority from the corresponding Japanese Patent Application No. 2019-014718 filed on Jan. 30, 2019, the entire contents of which are incorporated herein by reference.

The present invention relates to an operation range setting apparatus, a game apparatus, an operation range setting method, and a non-transitory computer-readable recording medium.

### BACKGROUND

Conventionally, a cognitive function training game that activates brain functions to prevent dementia has been proposed. For example, a game apparatus has been proposed in which multiple types of games are performed on one screen, thereby enhancing training effects such as dementia prevention.

In addition, in recent years, in elderly facilities, and the like, a usage has been proposed in which a cognitive function training game is conducted with the use of a large touch panel while there are viewers. However, in the cognitive function training game for the elderly using a large touch panel, a game operation area where a user operates (touch operation) on a game screen is large, resulting in an area that cannot be reached, which makes it difficult to perform an appropriate touch operation. This problem can occur outside of games. For example, when a document is displayed on a large touch panel and a touch operation is performed, if the document is displayed in an area that is difficult for a user to reach, it is difficult to perform an appropriate touch operation.

### SUMMARY OF THE INVENTION

An object of the present invention is to provide an operation range setting apparatus, a game apparatus, an operation range setting method, and a non-transitory computer-readable recording medium capable of improving the operability of touch operation in a large touch panel.

An operation range setting apparatus according to one aspect of the present invention includes a display controller that displays in order each of a plurality of object images at a different position on a display screen of a touch panel, an input detector that detects a touch position touched by a user on the display screen with respect to each of the plurality of object images displayed on the display screen by the display controller, and an operation range setter that sets an operation range indicating a range on the display screen where the user can operate on the basis of a plurality of touch positions corresponding to the plurality of object images detected by the input detector.

A game apparatus according to a different aspect of the present invention sets a game operation area where the user operates on a game screen on the basis of the operation range set in the operation range setting apparatus.

An operation range setting method according to an other aspect of the present invention executes, by one or more processors, displaying in order each of a plurality of object images at a different position on a display screen of a touch panel, inputting and detecting a touch position touched by a user on the display screen with respect to each of the plurality of object images displayed on the display screen by the inputting and displaying, and setting an operation range indicating a range on the display screen where the user can operate on the basis of a plurality of touch positions corresponding to the plurality of object images detected by the detecting.

A non-transitory computer-readable recording medium according to a different aspect of the present invention executes, by one or more processors, displaying in order each of a plurality of object images at a different position on a display screen of a touch panel, inputting and detecting a touch position touched by a user on the display screen with respect to each of the plurality of object images displayed on the display screen by the displaying, and setting an operation range indicating a range on the display screen where the user can operate on the basis of a plurality of touch positions corresponding to the plurality of object images detected by the inputting and detecting.

According to the present invention, it is possible to improve the operability of touch operation in a large touch panel.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an external view illustrating a schematic configuration of an operation range setting apparatus according to an embodiment of the present invention.

FIG. 2 is a block diagram illustrating a configuration of the operation range setting apparatus according to the embodiment of the present invention.

FIG. 3A is a diagram illustrating an example of a display screen of the operation range setting apparatus according to the embodiment of the present invention.

FIG. 3B is a diagram illustrating an example of the display screen of the operation range setting apparatus according to the embodiment of the present invention.

FIG. 3C is a diagram illustrating an example of the display screen of the operation range setting apparatus according to the embodiment of the present invention.

FIG. 3D is a diagram illustrating an example of the display screen of the operation range setting apparatus according to the embodiment of the present invention.

FIG. 3E is a diagram illustrating an example of the display screen of the operation range setting apparatus according to the embodiment of the present invention.

FIG. 4 is a table illustrating an example of display information stored in the operation range setting apparatus according to the embodiment of the present invention.

FIG. 5 is a table illustrating an example of operation information stored in the operation range setting apparatus according to the embodiment of the present invention.

FIG. 6 is a table illustrating an example of operation range setting information stored in the operation range setting apparatus according to the embodiment of the present invention.

FIG. 7 is a diagram illustrating an example of the display screen of the operation range setting apparatus according to the embodiment of the present invention.

FIG. 8 is a diagram illustrating an example of an operation range set in the operation range setting apparatus according to the embodiment of the present invention.

FIG. 9 is a flowchart for explaining an example of a procedure of an operation range setting process executed by the operation range setting apparatus according to the embodiment of the present invention.

FIG. 10 is a block diagram illustrating a configuration of a game apparatus according to an embodiment of the present invention.

FIG. 11A is a diagram illustrating an example of a game screen of a game apparatus according to a reference embodiment.

FIG. 11B is a diagram illustrating an example of the game screen of the game apparatus according to the reference embodiment.

FIG. 12A is a diagram illustrating an example of a game screen of a game apparatus according to an embodiment of the present invention.

FIG. 12B is a diagram illustrating an example of the game screen of the game apparatus according to the embodiment of the present invention.

### DESCRIPTION OF THE PREFERRED EMBODIMENTS

Hereinafter, embodiments of the present invention will be described with reference to the accompanying drawings. The following embodiments are examples embodying the present invention and does not have the character to limit the technical scope of the present invention.

### Operation Range Setting Apparatus 1

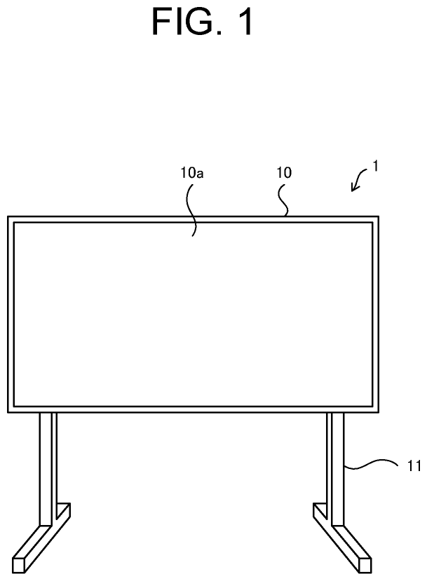

As illustrated in FIG. 1, an operation range setting apparatus 1 according to an embodiment of the present invention includes a touch panel display 10 where a touch input is possible by a user's finger or touch pen. The touch panel display 10 is supported by, for example, a leg 11. The user can use the touch panel display 10 in the vertical position. In addition, the touch panel display 10 may be configured to be used in the flat position. In this case, the user can use the touch panel display 10 as a table display. The touch panel display 10 is a large display and can be touched in the entire area of a display screen 10a.

For example, when the large touch panel display 10 is used to perform a game in which a user moves while performing a touch operation on the display screen 10a, an area that the user cannot reach is generated, making it difficult to perform an appropriate touch operation. Therefore, the operation range setting apparatus 1 according to this embodiment has a configuration capable of setting an optimal operation range for each user in the display screen 10a of the touch panel display 10.

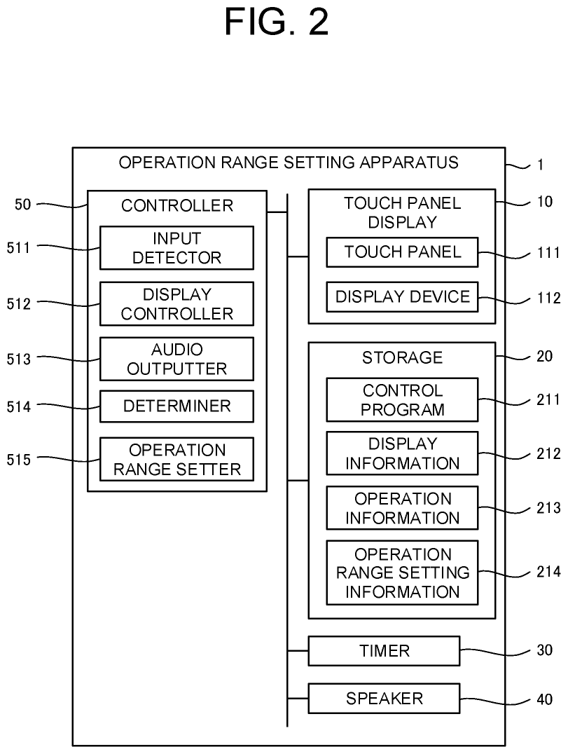

Specifically, as illustrated in FIG. 2, the operation range setting apparatus 1 includes the touch panel display 10, a storage 20, a timer 30, a speaker 40 and a controller 50. The touch panel display 10 is disposed outside the operation processing apparatus 1 and may be connected to the operation processing apparatus 1 via a network. The operation range setting apparatus 1 is an information processing apparatus such as a personal computer. The operation range setting apparatus 1 is not limited to one computer, and may be a computer system in which a plurality of computers operate in cooperation. In addition, various processes executed by the operation range setting apparatus 1 may be performed by one or more processors. The operation range setting apparatus 1 is an example of the operation range setting apparatus of the present invention.

The touch panel display 10 includes a touch panel 111 and a display device 112. The touch panel 111 may be a capacitive touch panel, a pressure sensitive type touch panel, or an infrared blocking type touch panel. That is, the touch panel 111 may be any device that can appropriately accept user operation input such as touch operation with a user's finger or touch pen. The display device 112 is, for example, a liquid crystal display. The display device 112 is not limited to the liquid crystal display, but may be a light emitting diode (LED) display, an organic electro-luminescence (EL) display, or the like. The touch panel 111 and the display device 112 may be integrally formed.

Here, an example of the operation range setting method executed in the operation range setting apparatus 1 will be described.

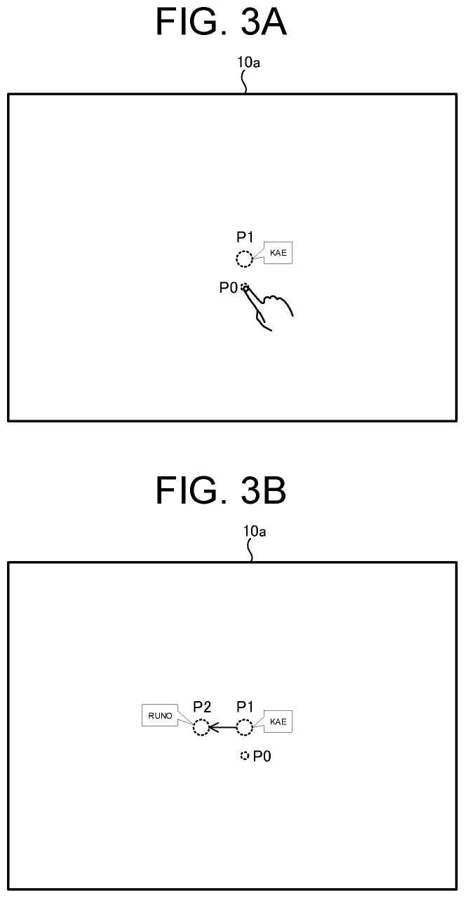

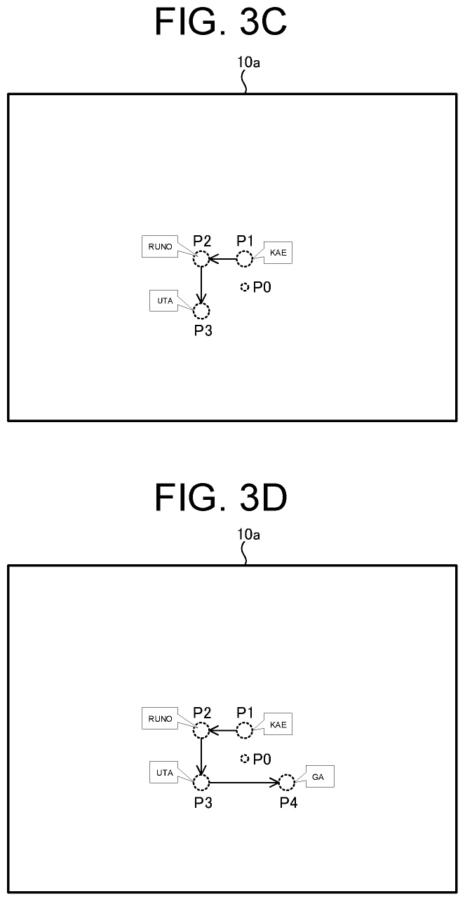

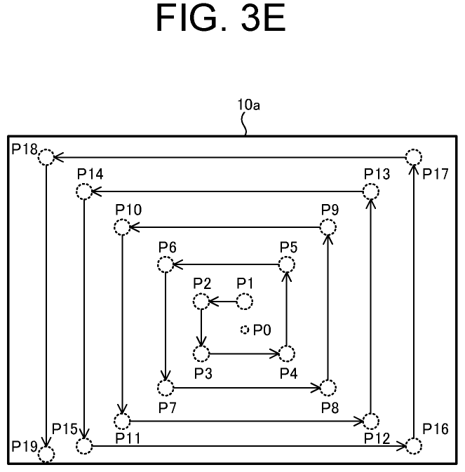

First, the operation range setting apparatus 1 displays an object image (for example, a “ball”) P1 that is a target of the touch operation on the touch panel display 10 with an arbitrary position where the user has first touched on the display screen 10a as a reference P0 (see FIG. 3). In doing so, the operation range setting apparatus 1 displays the ball P1 in accordance with a music rhythm. Here, the ball P1 is displayed in accordance with the first lyric “KAE” of a nursery rhyme “KAERU NO UTA”. The user touches the ball P1.

Next, the operation range setting apparatus 1 displays a ball P2 in accordance with the subsequent lyric “RUNO” (see FIG. 3B). The ball P1 is deleted and the ball P2 is displayed at a position to the left of the ball P1. The user touches the ball P2. Next, the operation range setting apparatus 1 displays a ball P3 in accordance with the subsequent lyric “UTA” (see FIG. 3C). The ball P2 is deleted, and the ball P3 is displayed at a position below the ball P2. The user touches the ball P3. Next, the operation range setting apparatus 1 displays a ball P4 in accordance with the subsequent lyric “GA” (see FIG. 3D). The ball P3 is deleted, and the ball P4 is displayed at a position to the right of the ball P3 and outside the ball P1. The user touches the ball P4.

In this way, the operation range setting apparatus 1 displays the object image in a spiral fashion in order in such a manner that the object image gradually spreads outward from the reference P0 (origin) in one direction (here, counterclockwise) in accordance with the music rhythm, and allows the user to touch the object image in order. FIG. 3E illustrates the display trajectory of the object image when the music is finished. The operation range setting apparatus 1 records information on a touch position indicating a position where the user has touched and a touch time indicating when the user has touched in the display order of the object images. Then, on the basis of these pieces of information, the operation range setting apparatus 1 determines a range where the user can operate on the display screen 10a (for example, a reachable range by hand), and sets the operation range of the user.

The operation range set in this way is set, for example, on the game screen as the range for displaying a game object image, a game operation area where the user operates, or the like. In addition, the operation range is set, for example, as an operation area when the user uses a table display. This makes it possible to improve the operability of touch operation in a large touch panel.

Next, a specific configuration of the operation range setting apparatus 1 for setting the operation range will be described.

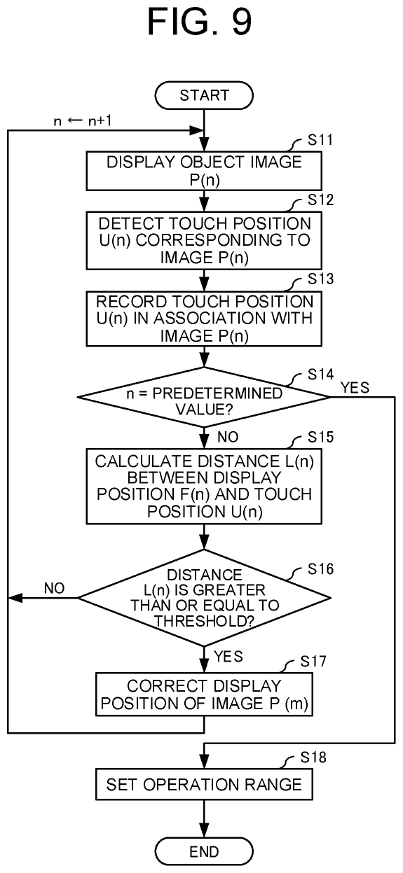

The storage 20 is a non-volatile storage including a semiconductor memory, a hard disk drive (HDD), or a solid state drive (SSD) that stores various types of information. For example, the storage 20 stores a control program 211 such as an operation range setting program for causing the controller 50 to execute an operation range setting process (see FIG. 9) described later. For example, the control program 211 is non-temporarily recorded on a computer-readable recording-medium such as a universal serial bus (USB), a certificate of deposit (CD), or a digital video disc (DVD), and is read by a reading device (not illustrated) such as a USB drive, a CD drive, or a DVD drive electrically connected to the operation range setting apparatus 1 and stored in the storage 20. The control program 211 may be downloaded from an external device via a network and stored in the storage 20.

In addition, the storage 20 includes display information 212 that is information of the object image displayed on the display device 112 in the operation range setting process described later, and operation information 213 that is information of touch operation by the user in the operation range setting process.

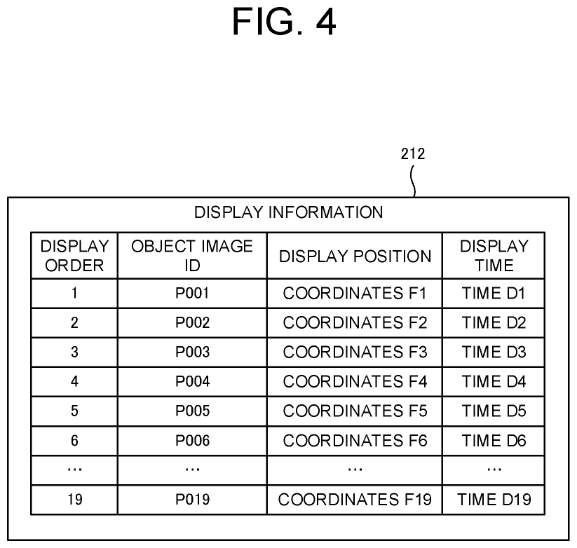

As illustrated in FIG. 4, the display information 212 includes information such as a “DISPLAY ORDER”, an “OBJECT IMAGE ID”, a “DISPLAY POSITION”, and a “DISPLAY TIME” for each object image displayed on the display screen 10a. The “DISPLAY ORDER” is an order in which the object images are displayed on the display screen 10a. The “OBJECT IMAGE ID” is identification information for identifying the object image. The “DISPLAY POSITION” is a position coordinates at which the object image is displayed on the display screen 10a. The “DISPLAY TIME” is a time when the object image is displayed on the display screen 10a. The display order of the object images is preset.

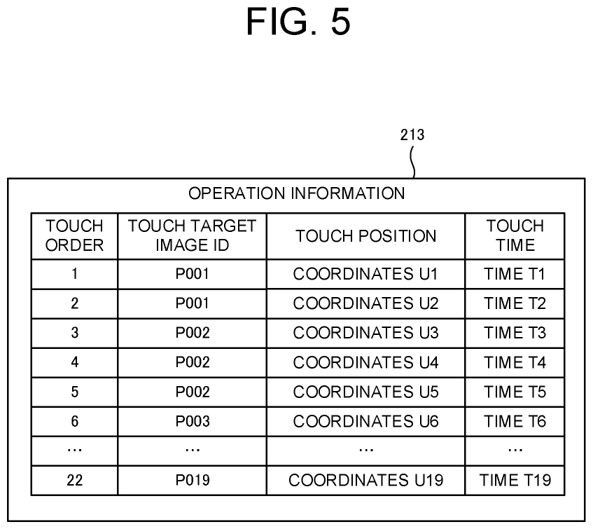

As illustrated in FIG. 5, the operation information 213 includes information such as a “TOUCH ORDER”, a “TOUCH TARGET IMAGE ID”, a “TOUCH POSITION”, and a “TOUCH TIME” for each touch operation of the user. The “TOUCH ORDER” is an order in which the user touches the display screen 10a. The “TOUCH TARGET IMAGE ID” is identification information for identifying the object image that is the target of a touch operation of the user. The “TOUCH POSITION” is a position coordinates that indicate a position where the user has touched the object image on the display screen 10a. The “TOUCH TIME” is a time when the user has touched the object image on the display screen 10a. The user may touch the object image once or multiple times. In the operation information 213, information on all touch operations of the user is registered. For this reason, in the example illustrated in FIG. 5, information on two touch operations is registered for an object image ID “P001”, and information on three touch operations is registered for an object image ID “P002”.

The operation range setting apparatus 1 displays the object image in accordance with the display order. Then, the operation range setting apparatus 1 records the information on the “DISPLAY POSITION” and the “DISPLAY TIME” in the display information 212 each time the object image is displayed, and records the information on the “TOUCH POSITION” and the “TOUCH TIME” in the operation information 213 every time a touch operation is performed by the user. Here, the storage 20 stores relative position coordinates based on the position (origin) where the user first touches the display screen 10a. With this, when the origin (the reference P0) is determined, the display position of the object image displayed on the display screen 10a is determined. The object image IDs “P001” to “P019” in the display information 212 illustrated in FIG. 4 correspond to the object images P1 to P19 illustrated in FIG. 3E.

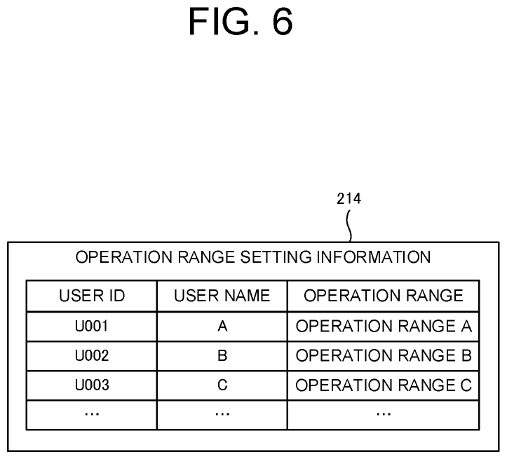

In addition, the storage 20 stores operation range setting information 214 that is an operation range set for each user. FIG. 6 is a table illustrating an example of the operation range setting information 214. The operation range setting information 214 includes information such as a “USER ID”, a “USER NAME”, and an “OPERATION RANGE”. The “USER ID” is identification information for identifying the user. The “USER NAME” is the name of the user. The “OPERATION RANGE” indicates a range where the user can operate on the display screen 10a. For example, the position coordinates of the four points that define a rectangular area (lower right coordinates, upper right coordinates, lower left coordinates, and upper left coordinates) is stored. The operation range of the user is specified by the position coordinates. The operation range setting apparatus 1 records the information on the “USER ID”, “USER NAME”, and “OPERATION RANGE” in the operation range setting information 214 each time the operation range setting process described later is executed.

Moreover, the storage 20 stores reproducible audio (music, etc.) data. The storage 20 also stores information such as a play speed and a number of playbacks of the audio.

The timer 30 measures a time. The controller 50 displays the object image on the display screen 10a on the basis of the time measured by the timer 30.

The speaker 40 outputs predetermined audio in accordance with a command of the controller 50. For example, the speaker 40 outputs the audio of music played by the controller 50. The speaker 40 may be provided in the case of the touch panel display 10.

The controller 50 includes control devices such as a central processing unit (CPU), a read-only memory (ROM), and a random-access memory (RAM). The CPU is a processor that executes various arithmetic processes. The ROM is a non-volatile storage in which control programs such as basic input/output system (BIOS) and operating system (OS) for causing the CPU to execute various arithmetic processes are stored in advance. The RAM is a volatile or non-volatile storage that stores various information, and is used as a temporary storage memory (work area) for various processes executed by the CPU. The controller 50 controls the operation range setting apparatus 1 by executing, on the CPU, various control programs stored in advance in the ROM or the storage 20.

Specifically, the controller 50 includes processors such as an input detector 511, a display controller 512, an audio outputter 513, a determiner 514, and an operation range setter 515. The controller 50 functions as the various processors by executing, on the CPU, various processes according to the operation range setting program. In addition, a part or all of the processors included in the controller 50 may be configured by an electronic circuitry. The operation range setting program may be a program for causing a plurality of processors to function as the various processors.

The input detector 511 detects a user input operation (touch operation) to the touch panel 111. The input detector 511 is an example of the input detector of the present invention. Specifically, the input detector 511 detects position coordinates (for example, a touch position) input (touch, swipe, etc.) by a user's finger or touch pen on an input surface (for example, the display screen 10a). For example, the input detector 511 detects the touch position by detecting a change in electrostatic capacitance between a finger or a touch pen and the input surface.

The input detector 511 detects a touch position touched by the user on the display screen 10a with respect to each of a plurality of object images displayed on the display screen 10a. In addition, the input detector 511 detects a time (touch time) when the touch operation was performed by the user. The input detector 511 records the information on the detected touch position and touch time in the operation information 213 (see FIG. 5).

Moreover, the input detector 511 records the information on the touch position and touch time in the operation information 213 (see FIG. 5) in association with the object image displayed on the display screen 10a, that is the target of a touch operation of the user.

The display controller 512 displays various information on the display device 112 of the touch panel display 10. The display controller 512 is an example of the display controller of the present invention. Specifically, in accordance with the display order (see FIG. 4), the display controller 512 displays in order each of a plurality of object images to be touched by the user at a different position on the display screen 10a. The display controller 512 displays the object images on the display screen 10a with the reference P0 (see FIG. 3A) detected by the input detector 511 as a reference position. The display positions (position coordinates) of the object images with respect to the reference are preset, and when the reference is determined, the display positions (position coordinates) of the object images on the display screen 10a are determined. For example, the display controller 512 can display in order a plurality of object images on the entire display screen 10a in accordance with a preset path.

In addition, the display controller 512 displays the object images on the display screen 10a in accordance with a predetermined audio rhythm. For example, the display controller 512 displays the object images on the display screen 10a in a spiral fashion in order in such a manner that the object images spread outward from the reference P0 in one direction (counterclockwise or clockwise) in accordance with a music rhythm. The display controller 512 may display the object images in such a manner that the display trajectory of the object images is rectangular or polygonal, or may display the object images in such a manner that the display trajectory of the object images is circular or elliptical.

The display controller 512 may or may not display the display trajectory connecting two consecutive object images on the display screen 10a. In addition, the display controller 512 may delete the display trajectory after a predetermined time has elapsed.

The audio outputter 513 outputs audio from the speaker 40 according to a predetermined rhythm. For example, the audio outputter 513 outputs audio of music stored in the storage 20 from the speaker 40. The audio outputter 513 is an example of the audio outputter of the present invention.

The determiner 514 calculates a distance between a position where the object image has been displayed (display position) and a position where the user has touched the object image (touch position). In addition, the determiner 514 calculates a difference (time difference) between a time when the object image has been displayed (display time) and a time when the user has touched the object image (touch time). The determiner 514 executes the calculation process with reference to the operation information 213, for example.

Here, when a touch operation is performed between the display time of the display order “n” and the display time of the display order “n+1”, the determiner 514 and the input detector 511 perform the following process, for example. When the distance between the touch position of the touch operation and the display position of the object image at the display order “n” is shorter than the distance between the touch position and the display position of the object image at the display order “n−1”, the determiner 514 determines that the touch operation is an operation performed on the object image at the display order “n”. In this case, the input detector 511 records the information on the touch position and touch time of the touch operation in the operation information 213 in association with the object image at the display order “n”. In addition, when the distance between the touch position of the touch operation and the display position of the object image at the display order “n−1” is shorter than the distance between the touch position and the display position of the object image at the display order “n”, the determiner 514 determines that the touch operation is an operation performed on the object image at the display order “n−1” after the object image at the display order “n” is displayed. In this case, the input detector 511 records the information on the touch position and touch time of the touch operation in the operation information 213 in association with the object image at the display order “n −1”.

Moreover, the determiner 514 may calculate a distance (error) between the display position of the object image and the touch position, and determine whether the error is equal to or greater than a threshold. Then, when the value is equal to or greater than the threshold, the display controller 512 may perform a correction process for displaying the object image at a position corrected from the preset path. In the correction process, the measurement direction of the error is not limited to the radial direction (extension line direction) from the reference P0, and may be the vertical direction or the horizontal direction. That is, the display controller 512 performs the correction process when the error is greater than or equal to the threshold in at least one of the radial direction, vertical direction, and horizontal direction. In addition, the display controller 512 may perform the above correction process in consideration of information (error) between the touch operation one lap before and the previous and subsequent touch operations.

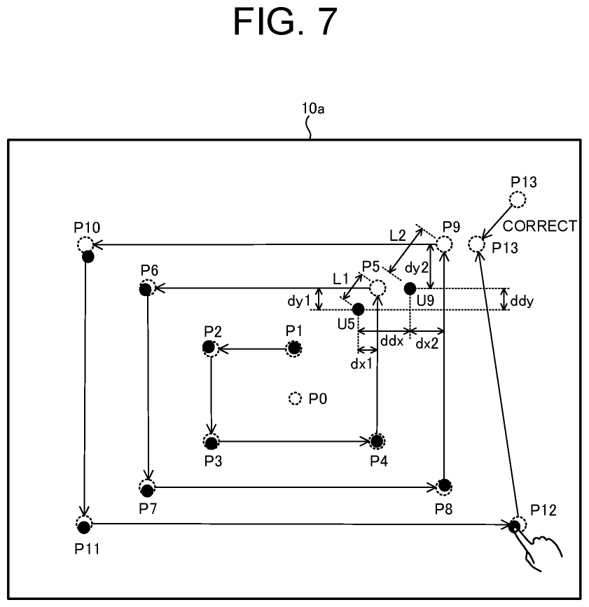

Moreover, the display controller 512 may correct the position of the object image by the same distance as the error or a distance different from the error. For example, in the example illustrated in FIG. 7, if the direction from the reference P0 to an object image P5 (upper right area) is difficult to touch for the user, the area outside the object image P5 may not be reachable by hand. Therefore, the display controller 512 corrects the position of the object image on the basis of the distance from a position U5 (corresponding to the “COORDINATES U5” in FIG. 5) that has been touched in the same direction most recently, not on the basis of the distance from a position F9 (corresponding to the “COORDINATES F9” in FIG. 4) where an object image P9 is to be displayed.

Furthermore, the display controller 512 may perform the above correction process in consideration of a touch mistake. For example, in the example illustrated in FIG. 7, the touch at the touch position U5 of the user has a large error, but the touch positions for the balls P6 and P8 are correctly touched, and thus the touch at touch position U5 may be a mistake.

Accordingly, for example, in the example illustrated in FIG. 7, the display controller 512 first displays the object image P9 at a preset position (a display position F5 (corresponding to “COORDINATES F5” in FIG. 4)). Suppose that a touch position U9 touched by the user with respect to this object image P9 has an error greater than the threshold from the object image P9. In this case, it can be determined that the touch operation at the touch position U9 is not a touch mistake but the object image P9 has been difficult to touch. In addition, the touch position U9 is touched outside the touch position U5, and touch positions U10 and U12 are touched with no large error. Thus, it can be determined that the position outside, though difficult to touch, can be guided by displaying an appropriate target.

Accordingly, the display controller 512 corrects the display position of an object image P13 to a position obtained by adding, to the touch position U9, a value derived from the difference (ddx, ddy) between the touch position U5 and the touch position U9 according to a certain law. In this case, the display controller 512 displays the object image P13 of the operation information 213 (see FIG. 5) at a position corrected from the above path. Then, the input detector 511 records the information on a touch position U13 and the touch time of the touch operation with respect to the object image P13 displayed at the corrected position in the operation information 213 in association with the object image P13.

When a single touch operation is performed on the object image, in the correction process, the error is calculated with the use of, for example, the touch position closest to the display position of the object image.

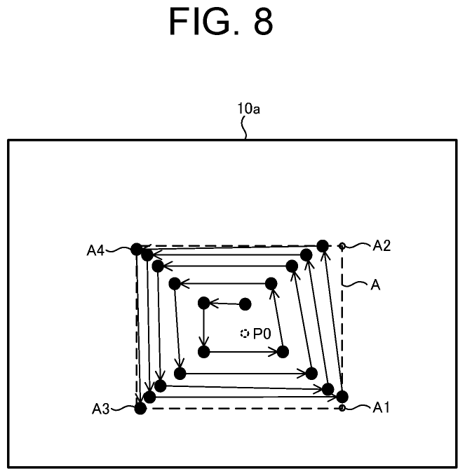

The operation range setter 515 sets an operation range indicating a range where the user can operate on the display screen 10a on the basis of the plurality of touch positions corresponding to the plurality of object images detected by the input detector 511. The operation range setter 515 is an example of the operation range setter of the present invention. Specifically, the operation range setter 515 sets the operation range on the basis of the operation information 213 illustrated in FIG. 5. FIG. 8 illustrates the touch position touched by the user. As illustrated in FIG. 8, the operation range setter 515 calculates a rectangular maximum range A from the trajectory connecting the touch positions included in the operation information 213, and sets the calculated maximum range A to the operation range. The operation range is specified by four position coordinates (lower right coordinates A1, upper right coordinates A2, lower left coordinates A3, and upper left coordinates A4) that define the maximum range A. The operation range setter 515 records information on the “USER ID”, “USER NAME”, and “OPERATION RANGE” in the operation range setting information 214 each time the operation range setting process described later is executed.

The operation range setter 515 sets the operation range corresponding to the display trajectory of the object image by the display controller 512. For example, when the display trajectory is rectangular, the operation range setter 515 sets the rectangular operation range, and when the display trajectory is elliptical, the operation range setter 515 sets the elliptical operation range.

In addition, the operation range setter 515 may set the operation range on the basis of the operation information 213 recorded by playing music once, or may set the operation range on the basis of the operation information 213 recorded by playing music multiple times.

### Operation Range Setting Process

Hereinafter, an example of the procedure of the operation range setting process executed by the controller 50 of the operation range setting apparatus 1 will be described with reference to FIG. 9. The controller 50 of the operation range setting apparatus 1 starts the execution of an operation range setting program in response to the user's operation, thereby staring the operation range setting process. First, the controller 50 notifies the user of a rule in such a manner that the user touches a plurality of the object images displayed on the display screen 10a in order with a finger in accordance with a music rhythm.

The present invention can be understood as an invention of an operation range setting method for executing one or more steps included in the operation range setting process. In addition, one or more steps included in the operation range setting process described here may be omitted as appropriate. Moreover, each step in the operation range setting process may have a different execution order within an extent in which the same operation effect is exhibited. Furthermore, while an example will be described in which each step in the operation range setting process is executed by the controller 50, in a different embodiment, each step in the operation range setting process may be executed in a distributed manner by a plurality of processors.

In step S11, the controller 50 displays on the display screen 10a an object image P(n) whose display order is nth. When the display order is first, the controller 50 first notifies the user to touch an arbitrary position on the display screen 10a (a position that can be easily touched). When the user touches the arbitrary position, the controller 50 sets the position to the reference P0. Subsequently, for example, as illustrated in FIG. 3A, the controller 50 plays music and displays the object image P1 on the display screen 10a on the basis of the reference P0 in accordance with a rhythm. In addition, the controller 50 detects a display time D1 when the object image P1 has been displayed.

Next, in step S12, the controller 50 detects a touch position U(n) touched by the user with respect to the object image P(n). In addition, the controller 50 detects a touch time T(n) when the touch position U(n) has been touched by the user with respect to the object image P(n).

Next, in step S13, the controller 50 records the information on the detected touch position U(n) and touch time T(n) in the operation information 213 (see FIG. 5) in association with the object image P(n).

In step S14, the controller 50 determines the display order “n”. When the display order “n” has not reached a preset order (predetermined value) (S14: NO), the process proceeds to step S15. When the display order “n” has reached the predetermined value, the process proceeds to step S18. The predetermined value indicates the number of times the user performs the touch operation, and is set on the basis of, for example, the time it takes to play the music once. In the example illustrated in FIG. 3E, the predetermined value is set to “19”.

In step S15, the controller 50 calculates a distance L(n) between a display position F(n) of the object image and the touch position U(n). In addition, the controller 50 detects the direction of the touch position U(n) with respect to the display position F(n).

Next, in step S16, the controller 50 determines whether the distance L(n) is greater than or equal to a threshold. If determining that the distance L(n) is greater than or equal to the threshold (S16: YES), the process proceeds to step S17. On the other hand, if determining that the distance L(n) is less than the threshold (S16: NO), the controller 50 advances the display order “n” to the next order “n+1”, and the process returns to step S11.

In step S17, the controller 50 corrects the display position of an object image P(m) from the display position of the preset path. For example, the controller 50 corrects, from the display position of the path, the object image P(m) arranged in the same direction as the display position of the object image P(n) when viewed from the reference P0, for example, on the extension of the straight line passing through the display position F(n) of the object image P(n) from the reference P0 (origin). In other words, the object image P(m) is an image arranged in the vicinity of the extension of a straight line passing through the object image P(n) from the origin of the path in the preset path. The controller 50 displays the object image P(m) at the corrected display position, and records the information on the display position in the operation information 213 (see FIG. 5).

After step S17, the controller 50 advances the display order “n” to the next order “n+1” and returns to the process of step S11. The controller 50 repeats the above process until the display order “n” reaches the predetermined value.

When the display order “n” reaches the predetermined value, in step S18, the controller 50 sets the operation range of the user. Specifically, the controller 50 sets the operation range on the basis of the operation information 213 illustrated in FIG. 5. For example, as illustrated in FIG. 8, the controller 50 calculates a rectangular maximum range A from the trajectory connecting the touch positions included in the operation information 213, and sets the calculated maximum range A to the operation range.

In the operation range setting process, steps S15 to S17 may be omitted. In this case, if the display order “n” has not reached the predetermined value in step S14 (S14: NO), the process returns to step S11.

As described above, the operation range setting apparatus 1 according to the embodiment of the present invention displays in order each of a plurality of object images at a different position on the display screen 10a, and allows the user to touch to target the object images, thereby setting an operation range that is within the reach of the user's hand. This makes it possible to set, for each user, an operation range that is easy for the user to operate. In addition, the operation range setting apparatus 1 displays the object image according to a music rhythm. This allows the user to set his/her operation range while having fun as a game. Moreover, the user can operate a touch panel within the set operation range. Therefore, it is possible to improve the operability of the touch operation in a large touch panel.

The present invention is not limited to the above-described embodiment, and may be the following embodiments.

As a different embodiment, the operation range setting apparatus 1 may set the operation range on the basis of a touch operation performed with one hand (right hand or left hand), or performed with both hands of the user. In addition, the operation range setting apparatus 1 may be configured to switch between a one-hand mode and a two-hand mode. In this configuration, the operation range setting apparatus 1 may make the display position of the object image in the one-hand mode different from the display position of the object image in the two-hand mode. For example, the operation range setting apparatus 1 widens the range where the object image is displayed in the case of the two-hand mode compared with the range where the object image is displayed in the case of the one-hand mode. As a result, the operation range set in the case of the two-hand mode can be made larger than the operation range set in the case of the one-hand mode.

In addition, as a different embodiment, the operation range setting apparatus 1 may delay the display time (display timing) of an object image to be displayed next from a preset display timing when the time difference between the display time of the object image and the touch time corresponding to the object image is equal to or greater than a threshold. In this case, it is preferable that the operation range setting apparatus 1 also delays a music play speed. This improves the success rate of the touch operation of the user. Moreover, the operation range can be set in accordance with the speed of the touch operation of the user.

Furthermore, in a different embodiment, the operation range setting apparatus 1 may delay the display time (display timing) of an object image to be displayed next from a preset display timing when the distance between the display position of an object image and the touch position corresponding to the object image is greater than or equal to the threshold. This improves the success rate of the touch operation of the user. Therefore, the user can set the operation range while having fun.

### Game Apparatus 2

A game apparatus 2 executes a predetermined game on the basis of the operation range set by the operation range setting apparatus 1. That is, the game apparatus 2 sets a game operation area where the user operates on the game screen 10b on the basis of the operation range set in the operation range setting apparatus 1.

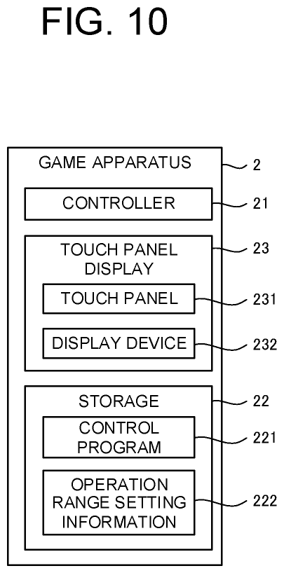

As illustrated in FIG. 10, the game apparatus 2 includes a controller 21, a touch panel display 23, and a storage 22. The touch panel display 23 may be the same as or different from the touch panel display 10 included in the operation range setting apparatus 1. In a case where the touch panel display 23 is the same as the touch panel display 10, the operation range setting apparatus 1 and the game apparatus 2 may be connected to the touch panel display 10 via a network. In addition, the operation range setting apparatus 1 and the game apparatus 2 may be included in one computer. That is, the operation range setting apparatus 1 may have the function of the game apparatus 2.

The storage 22 stores a control program 221 such as a game program for causing the controller 21 to execute a game process. For example, the control program 221 is recorded non-temporarily on a computer-readable recording-medium such as a USB, a CD or a DVD, and is read by a reading device (not illustrated) such as a USB drive, a CD drive, or a DVD drive electrically connected to the game apparatus 2 and stored in the storage 22. The control program 221 may be downloaded from an external device via the network and stored in the storage 22.

The storage 22 stores operation range setting information 222 indicating the operation range set by the operation range setting apparatus 1. The operation range setting information 222 is the same as the operation range setting information 214 stored in the operation range setting apparatus 1.

The controller 21 includes control devices such as a CPU, a ROM, and a RAM. The CPU is a processor that executes various arithmetic processes. The ROM is a non-volatile storage in which control programs such as BIOS and OS for causing the CPU to execute various arithmetic processes are stored in advance. The RAM is a volatile or non-volatile storage that stores various information, and is used as a temporary storage memory (work area) for various processes executed by the CPU. The controller 21 controls the game apparatus 2 by executing, on the CPU, various control programs stored in advance in the ROM or the storage 22.

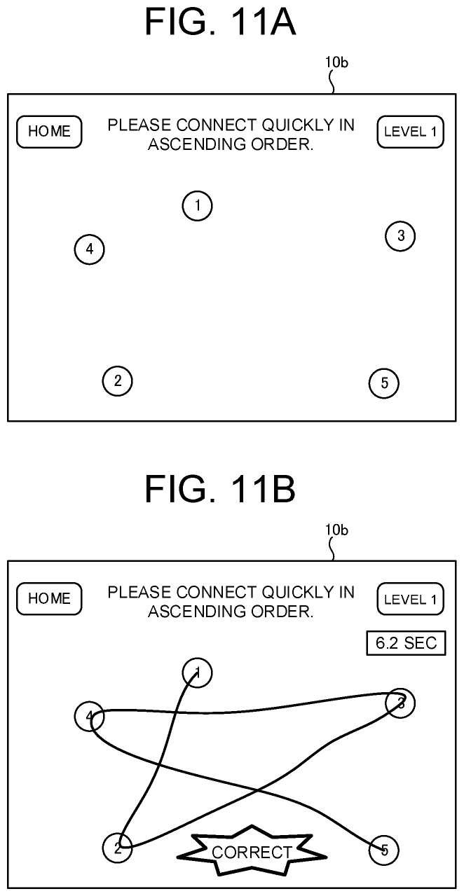

Here, an example of a game executed in the game apparatus 2 will be illustrated. Here, a beads connecting game is taken as an example. The beads connecting game is such that, for example, in the game screen 10b illustrated in FIG. 11A, a ball is connected to a next ball while the user touches the balls in ascending order of the numbers. FIG. 11B illustrates a case of a correct answer.

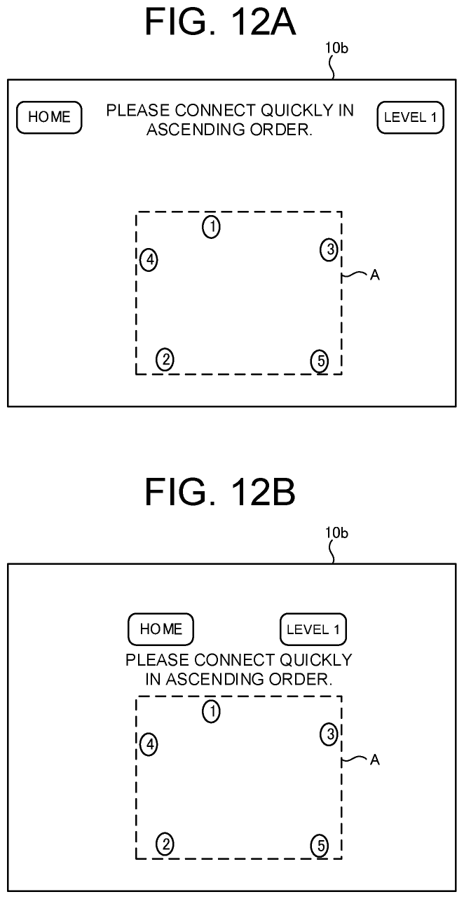

In this embodiment, for example, when a user A logs in with a user ID in the game apparatus 2, the controller 21 refers to the operation range setting information 222 of the storage 22 and acquires an operation range A (see FIG. 6) set for the user A. Then, the controller 21 sets the acquired operation range A to the game operation area operated by the user in the game screen 10b. Specifically, as illustrated in FIG. 12A, the controller 21 displays a game object image that requires a user input operation (a touch operation, or a swipe operation) on the game screen 10b in such a manner that the game object image is within the operation range A.

As illustrated in FIG. 12A, the controller 21 may reduce the size of the game object image in accordance with the size of the operation range A. In addition, the controller 21 may change the display position and size of fixed images as illustrated in FIG. 12B in consideration of the balance of position and size with the fixed images other than the game object image.

The game apparatus 2 may notify the user A that the operation range setting process is executed when the user A's game execution count reaches a predetermined number of times. When the user A selects to execute the operation range setting process, the operation range setting apparatus 1 starts the operation range setting process and resets the operation range. As a result, the operation range for the user A is updated.

The operation range setting apparatus 1 according to the present invention can be configured by freely combining each of the embodiments described above, or by appropriately modifying each of the embodiments or omitting some of the embodiments within the scope of the invention described in each claim.

It is to be understood that the embodiments herein are illustrative and not restrictive, since the scope of the disclosure is defined by the appended claims rather than by the description preceding them, and all changes that fall within metes and bounds of the claims, or equivalence. of such metes and bounds thereof are therefore intended to be embraced by the claims.

What is claimed is:

1. An operation range setting apparatus comprising:
a display controller that displays in order each of a plurality of object images at a different position on a display screen of a touch panel;
an input detector that detects a touch position touched by a user on the display screen with respect to each of the plurality of object images displayed on the display screen by the display controller; and
an operation range setter that sets an operation range indicating a range on the display screen, the range where the user operates on a basis of a plurality of the touch positions corresponding to the plurality of object images detected by the input detector.

2. The operation range setting apparatus according to claim 1, wherein the display controller displays each of the plurality of object images on the display screen so as to spread each of the plurality of object images outward in a spiral shape.

3. The operation range setting apparatus according to claim 1, further comprising an audio outputter that outputs audio according to a predetermined rhythm,
wherein the display controller displays in order each of the plurality of object images on the display screen according to the predetermined rhythm of the audio.

4. The operation range setting apparatus according to claim 1, wherein the display controller displays each of the plurality of object images on the display screen according to a preset path.

5. The operation range setting apparatus according to claim 4, further comprising a determiner that determines whether a distance between a first display position where a first object image is displayed and a first touch position touched by the user with respect to the first object image is greater than or equal to a threshold,
wherein when the determiner determines that the distance is greater than or equal to the threshold, the display controller displays a second object image displayed after the first object image at a position corrected from the path.

6. The operation range setting apparatus according to claim 5, wherein the second object image is an image arranged on the path in a vicinity of an extension of a straight line passing through the first object image from an origin of the path.

7. The operation range setting apparatus according to claim 4, wherein, in a first object image and a second object image displayed next to the first object image, when a time difference between a display time of the first object image and a time when the user touches with respect to the first object image is equal to or greater than a threshold, the display controller delays a display timing of the second object image from a preset display timing.

8. A game apparatus that sets a game operation area where the user operates on a game screen on a basis of the operation range set in the operation range setting apparatus according to claim 1.

9. An operation range setting method for executing, by one or more processors:
displaying in order each of a plurality of object images at a different position on a display screen of a touch panel;
inputting and detecting a touch position touched by a user on the display screen with respect to each of the plurality of object images displayed on the display screen by the displaying; and
setting an operation range indicating a range on the display screen, the range where the user operates on a basis of a plurality of the touch positions corresponding to the plurality of object images detected by the inputting and the detecting.

10. A non-transitory computer-readable recording medium storing a program for causing one or more processors to execute:
displaying in order each of a plurality of object images at a different position on a display screen of a touch panel;
inputting and detecting a touch position touched by a user on the display screen with respect to each of the plurality of object images displayed on the display screen by the displaying; and
setting an operation range indicating a range on the display screen, the range where the user operates on a basis of a plurality of the touch positions corresponding to the plurality of object images detected by the inputting and the detecting.
